(19) United States
(12) Patent Application Publication
(10) Pub. No.: US 2014/0154003 A1
(43) Pub. Date: Jun. 5, 2014

(54) Securing of a Blow-Mould Component

(71) Applicant: Bayerische Motoren Werke Aktiengesellschaft, Muenchen (DE)

(72) Inventors: Roland HAIN, Muenchen (DE); Franz BRANDL, Schwandorf (DE); Ferenc KELEMEN, Muenchen (DE)

(73) Assignee: Bayerische Motoren Werke Aktiengesellschaft, Muenchen (DE)

(21) Appl. No.: 14/174,962

(22) Filed: Feb. 7, 2014

Related U.S. Application Data
(63) Continuation of application No. PCT/EP2012/064483, filed on Jul. 24, 2012.

(30) Foreign Application Priority Data
Aug. 9, 2011 (DE) 10 2011 080 663.6

(51) Int. Cl. F16B 17/00

(52) U.S. Cl. CPC F16B 17/00
USPC 403/345

(57) ABSTRACT

For fastening to a carrier component, a blow-molded component has at least one integrally molded tab with an oblong recess. A detent hook on the carrier component is able to reach behind the tab when passed through the recess. The detent hook is more rigid than the tab, wherein the rigidity describes the resistance of a body to deformation by a force or a torque.

### CROSS REFERENCE TO RELATED APPLICATIONS

This application is a continuation of PCT International Application No. PCT/EP2012/064483, filed Jul. 24, 2012, which claims priority under 35 U.S.C. §119 from German Patent Application No. 10 2011 080 663.6, filed Aug. 9, 2011, the entire disclosures of which are herein expressly incorporated by reference.

### BACKGROUND AND SUMMARY OF THE INVENTION

The invention relates to a fastening of a blow-molded component to a carrier component, the blow-molded component having at least one integrally molded tab for the fastening.

In the entry “Blow Molding” in the Wikipedia on-line dictionary of Aug. 4, 2011, it is indicated that blow-molded components always are hollow bodies. For their production, a tube of hot moldable plastic is first extruded in a vertically downward direction. In this case, the material thickness in the tube is controlled corresponding to the shape of the component to be produced. Subsequently, a mandrel moves into the tube, and a two-part die, which is still open at this point in time, will close and surround the tube together with the mandrel. By means of the mandrel, compressed air will then be pressed into the tube, whereby the latter is inflated, is pressed against the contour of the die and is cooled. The plastic material thereby adapts itself to the predefined shape and becomes solid.

Bottles, canisters or barrels, for example, are typical blow-molded components. However, technical components for ducts, bellows, suitcase shells or fuel tanks can also be blow-molded.

For the fastening of such blow-molded components, it is customary to provide at least one integrally molded tab. This tab is situated in the parting plane between the two die halves. As a result, the tab can be integrally molded simultaneously with the blow molding. By means of the blown-in compressed air, the plastic material is pressed into the gap between the two die halves for the tab. The tab may have a round recess so that the blow-molded component can be screwed on. In this case, the screw projects with its shaft through the recess, while the screw head rests against the tab.

It is an object of the invention to create a particularly simple fastening possibility for a blow-molded component.

This and other objects are achieved by a fastening of a blow-molded component to a carrier component, the blow-molded component having at least one integrally molded tab for the fastening. The carrier component has a detent hook and the tab has an oblong recess, so that the detent hook can reach behind the tab through the recess. The detent hook being more rigid than the tab.

According to the invention, a blow-molded component has at least one integrally formed tab with an oblong recess for the fastening to a carrier component, a detent hook at a carrier component being able to reach behind the tab. In this case, the detent hook is more rigid than the tab. The rigidity describes the resistance of a body to deformation by a force or a torque. The rigidity of a body is a function of its material as well as of its geometry. While, up to now, blow-molded components having a tab have only been screwed on, it now becomes possible to also lock the blow-molded components. This represents a significantly simpler and more cost-effective fastening possibility. The time required for establishing the fastening is also significantly shorter than for establishing a screwed connection.

The detent hook preferably consists of a rigid material, so that the detent hook has practically no flexibility. The material of the detent hook may, for example, be a plastic material reinforced by glass fibers or glass beads. The detent hook may also be constructed in one piece with the carrier component. The detent hook advantageously consists of at least one oblong basic body which projects from the carrier component. At the free end of the basic body, a detent lug is situated at least on one side. In a cross-sectional view, such a detent lug usually is essentially triangular. With one side, the detent lug rests against the basic body. The detent lug becomes increasingly wide from the free end of the basic body toward the carrier component. During the mounting, the detent hook can thereby slide like a wedge through the oblong recess in the tab.

Advantageously, the recess in the tab is narrower than the detent hook in the area of the detent lug. The detent lug thereby fits through the recess only because of the fact that the edge areas of the tab surrounding the recess yield elastically. In this case, it is important that the detent hook is so rigid that it virtually does not yield during the mounting. As soon as the detent lug has been pressed through the recess, the surrounding edge areas of the tab return to their initial position. This results in the desired latching-from-behind of the detent hook and thereby in the desired fastening. This is a very simple and, therefore, also cost-effective type of fastening.

Viewed in the longitudinal direction of the recess, a nipple preferably projects in the central area from a longitudinal side of the edge areas surrounding the recess, into the recess. The nipple may advantageously be constructed in one piece with the tab. The nipple is mounted on the side of the recess which faces away from the detent lug of the detent hook. Although it increases the resistance during the fitting of the detent hook through the recess, inversely, it also increases the stability under load and thereby the safety of the fastening when, after the fitting-through of the detent hook, it elastically returns to its initial position. As a result, it presses against the detent hook and thus presses the latched-from-behind detent lug against the edge area surrounding the recess, so that the latching-from-behind cannot accidentally be released. This nipple decisively contributes to the fact that the fastening according to the invention can be produced in a process-reliable manner.

Other objects, advantages and novel features of the present invention will become apparent from the following detailed description of one or more preferred embodiments when considered in conjunction with the accompanying drawings.

### BRIEF DESCRIPTION OF THE DRAWINGS

The drawing illustrates an embodiment of the invention by means of which the invention will be described in detail in the following.

FIG. 1 is a schematic three-dimensional view of a blow-molded air-guiding duct with an integrally molded tab in an oblong recess;

FIG. 2 is an enlarged schematic view of the tab illustrated in FIG. 1;

FIG. 3 is a schematic view of a carrier component with an integrally molded detent hook; and

FIG. 4 is a schematic view of the carrier component of FIG. 3 with the air-guiding duct of FIGS. 1 and 2 fastened thereto.

### DETAILED DESCRIPTION OF THE DRAWINGS

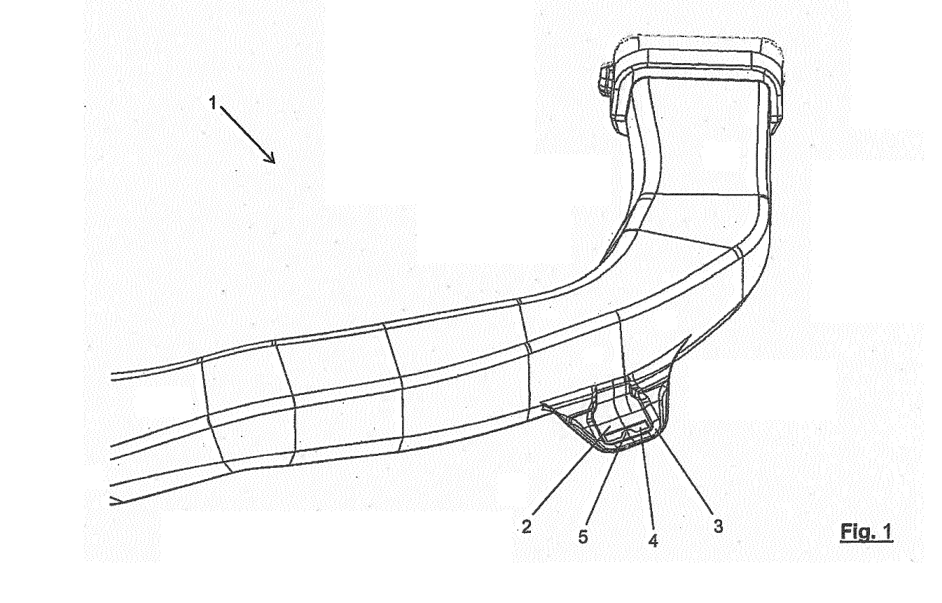

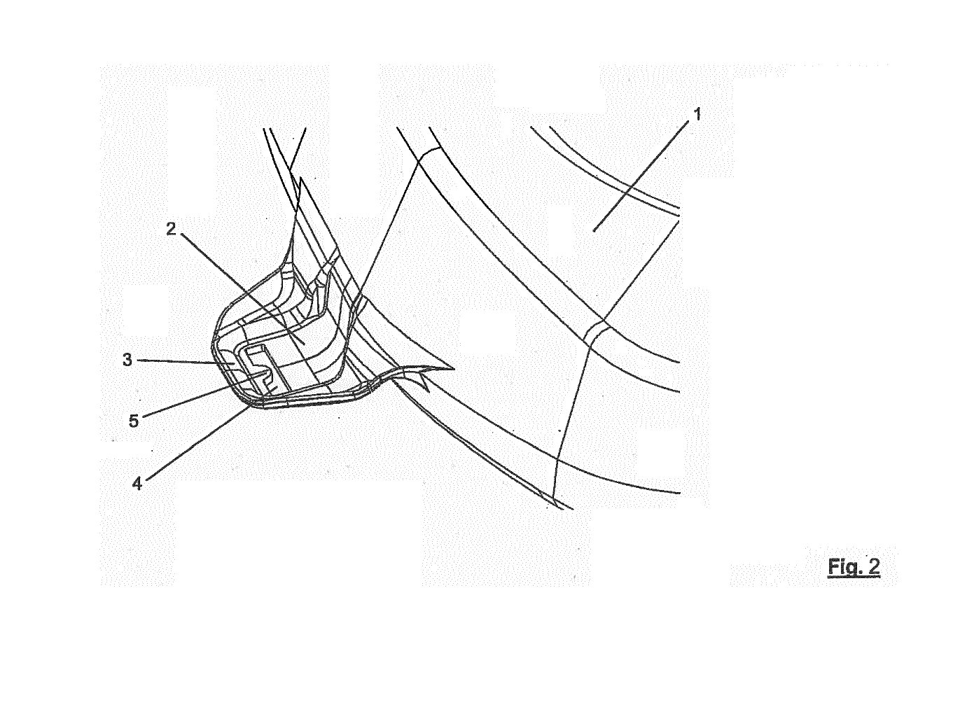

FIGS. 1 and 2 illustrate an air-guiding duct 1, which is required in an instrument panel of a motor vehicle for feeding air to the air outlet openings in the instrument panel. Such an air-guiding duct 1 does not have to withstand any large forces. However, it should be as light and cost-effective as possible. This air-guiding duct 1 is therefore ideally suited for being constructed as a blow-molded component. A blow-molded air guiding duct 1 may have very thin wall thicknesses, so that it will have a low weight. The production costs for such an air-guiding duct 1 are also very favorable compared to all other production processes.

As a blow-molded component, the air-guiding duct 1 has to be fastened to the covering part of the instrument panel on the underside not visible from the passenger compartment. The covering part therefore forms the carrier component, to which the air-guiding duct 1 is to be fastened.

For the fastening, the air-guiding duct 1 has at least one tab 2, which is integrally molded in one piece. This tab 2 is situated in the parting plane of the die halves of the blow-molding die, so that it can be simultaneously integrally molded. By pressing the compressed air into the plastic tube, the latter is pressed against the die halves and into the recess for the tab 2.

The tab 2 has an exterior edge area 3, which has a greater wall thickness than the center area of the tab 2. An oblong recess 4 is situated in the center area of the tab 2. Viewed in the longitudinal direction of the recess 4, a nipple 5 projects in the central area from the edge area surrounding the recess 4, into the recess 4. This nipple 5 approximately has the shape of a semicircle.

The entire air-guiding duct 1 with the integrally molded tab 2 and the nipple 5 consists of one piece of a relatively soft thermoplastic polyurethane.

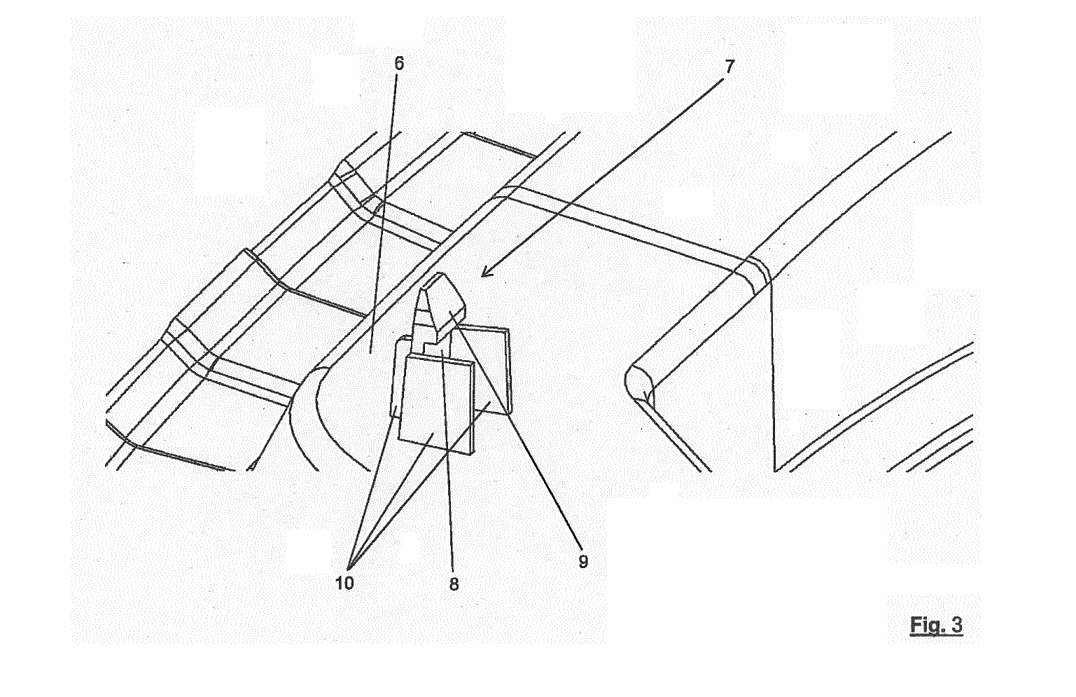

FIG. 3 illustrates the covering part 6 to which the air-guiding duct 1 with the integrally molded tab 2 can be fastened. The covering part 6 consists of a rigid polyamide. A detent hook 7 is integrally molded in one piece to the covering part 6. This detent hook 7 has an oblong basic body 8, which projects in the upward direction from the covering part 6. A detent lug 9, which is triangular in a cross-sectional view, is integrally molded on one side to the free upper end of the basic body 8. This detent lug 9 becomes continuously wider in a wedge-shaped fashion from its “tip” in a downward direction toward the basic body 8. The basic body 8 is additionally supported by way of three ribs 10 at the covering part 6, so that it is very rigid also with respect to its geometrical design.

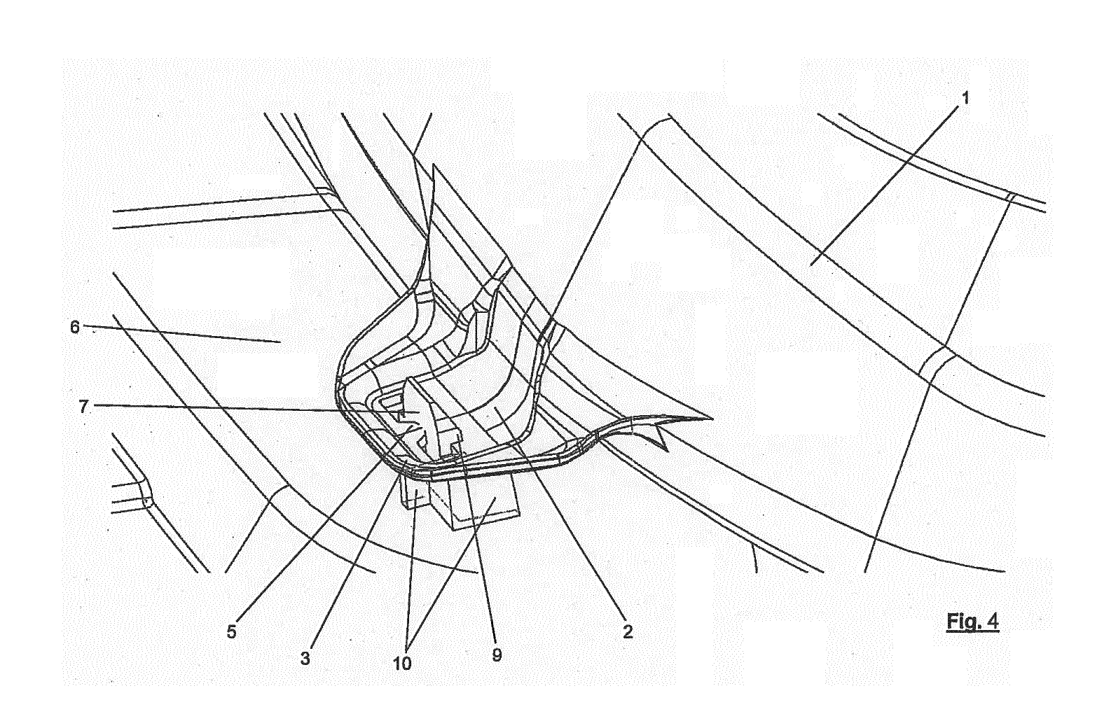

FIG. 4 illustrates the covering part 6 with the air-guiding duct 1 fastened thereto. It is easily visible that the detent lug 9 reaches in a form-locking manner behind the edge area of the recess 4. The nipple 5 rests against the detent hook 7 in a slightly elastically deformed manner and presses the latter against the opposite edge area of the recess 4. The nipple 5 thereby prevents the air-guiding duct 1 with the tab 2 and the recess 4 from being accidentally displaced relative to the detent hook 7 such that the detent lug 9 would no longer reach behind the edge area of the recess 4. This nipple 5 therefore significantly contributes to the fact that, by way of this simple locking, the fastening connection will reliably hold.

During the mounting of the air-guiding duct 1, some force has to be applied in order to press the detent hook 7 through the recess 4 because the detent hook 7 together with the detent lug 9 is wider than the recess 4. By means of the applied force, the edge areas of the tab 2 surrounding the recess 4 and the nipple 5 are elastically pressed to the side, so that the detent hook 7 fits through the elastically widened recess 4. The wedge shape of the upper end of the detent hook 7 is also helpful in this case. As soon as the particularly wide detent lug 9 has dipped through the recess 4, the elastically deformed edge areas and the nipple 5 will move back in the direction of their initial position. In the process, the nipple 5 presses against the oblong basic body 8 of the detent hook 7 on the side facing away from the detent lug 9, so that the tab 2 of the air-guiding duct shifts slightly, and the detent lug 9 reaches securely behind the surrounding edge area of the recess 4. The three ribs 10 are used as a stop during the mounting 2, so that the tab 2 cannot be pressed too far downward over the detent hook 7. In a very simple and rapid manner, this results in a secure fastening of the blow-molded air-guiding duct 1 to the covering part 6, which is used here as the carrier component.

When designing the fastening connection, attention should be paid to the fact that the detent hook 7 has a design that is as rigid as possible, so that the entire required elastic flexibility is virtually ensured exclusively by way of the corresponding design of the tab 2. The design of the width of the recess 4 has to be coordinated with the width of the basic body 8 and the width of the detent lug 9 of the detent hook 7. On the one hand, the force required for the mounting should not be too high, in order to be able to ensure an ergonomic manual mounting and to be able to exclude damage to the recess 4 during the mounting. On the other hand, after the mounting, the fastening has to hold in order to ensure a reliable process. For this purpose, the corresponding design of the size, shape and thickness of the nipple 5 can also be a contributing factor.

So far, blow-molded components had always been screwed to carrier components. Only the construction of the fastening according to the invention permits a latching-from-behind, which can be implemented much more cost-effectively and rapidly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fastening connection, comprising:
a blow-molded component having at least one integrally molded tab configured for the fastening connection, the tab having an oblong recess;
a carrier component having a detent hook, the detent hook being configured to extend behind the tab when passed through the recess, the detent hook being more rigid than the tab.

2. The fastening connection according to claim 1, wherein the detent hook comprises a rigid material.

3. The fastening connection according to claim 2, wherein:
the detent hook has an oblong basic body that projects away from the carrier component, and
a detent lug is located at an end of the basic body facing away from the carrier component, the detent lug being situated on at least one side of the basic body.

4. The fastening connection according to claim 3, wherein the recess is narrower than the detent hook in an area of the detent lug.

5. The fastening connection according to claim 2, wherein the recess is narrower than the detent hook in an area of the detent lug.

6. The fastening connection according to claim 4, wherein edge areas of the tab surrounding the recess are elastically yieldable when the detent hook with the detent lug is pressed through the recess.

7. The fastening connection according to claim 5, wherein edge areas of the tab surrounding the recess are elastically yieldable when the detent hook with the detent lug is pressed through the recess.

8. The fastening connection according to claim 1, wherein
the tab comprises a nipple that projects from a longitudinal side of the recess into the recess in a center area when viewed in a longitudinal direction of the recess.

9. The fastening connection according to claim 8, wherein the nipple is formed in one piece with the tab.

10. The fastening connection according to claim 9, wherein the nipple is arranged on a side of the detent hook that faces away from the detent lug.

11. The fastening connection according to claim 8, wherein the nipple is arranged on a side of the detent hook that faces away from the detent lug.

12. The fastening connection according to claim 1, wherein an exterior edge area of the tab has a greater wall thickness than a central area of the tab in which the recess is located.

13. The fastening connection according to claim 1, wherein the tab is located on the blow-molded component in an area corresponding to a parting plane of a blow-molding die that forms the blow-molded component.
